(19) United States
(12) Patent Application Publication
(10) Pub. No.: US 2007/0188341 A1
(43) Pub. Date: Aug. 16, 2007

(54) Residential signal beacon

(76) Inventor: Billie Jo Seifert, Crystal, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/638,168

(22) Filed: Dec. 13, 2006

Related U.S. Application Data
(63) Continuation-in-part of application No. 10/876,238, filed on Jun. 24, 2004.
(60) Provisional application No. 60/480,976, filed on Jun. 24, 2003.
(60) Provisional application No. 60/750,516, filed on Dec. 15, 2005.

(51) Int. Cl. G08B 5/36

(52) U.S. Cl. 340/815.53

(57) ABSTRACT

A residential signal beacon includes a prominent illuminated or reflective display for a resident's address along with a selectively activatable beacon for drawing attention to the resident's address. The beacon is operable by a remote control apparatus coupled to a telephone or a home security system, so as to be selectively activatable and de-activatable. The residential signal beacon may be readily movable and may be secured, for example, by a weighted base or stakes driven into the ground.

### CLAIM TO PRIORITY

This application is a continuation in part of U.S. patent application Ser. No. 10/876,238 entitled “Residential Signal Beacon” filed Jun. 24, 2004 which in turn claims priority to U.S. provisional patent application No. 60/480,976 entitled “Residential Signal Beacon” filed Jun. 24, 2003. This application also claims priority to U.S. provisional patent application No. 60/750,516 entitled “Residential Signal Beacon” filed Dec. 15, 2005.

### TECHNICAL FIELD

The present invention relates to a sign for identifying the address of a residence, for identifying the location of that residence, and more specifically to a lighting apparatus and method to aid in the location of such residence at night or during an emergency.

### BACKGROUND OF THE INVENTION

It is sometimes difficult to identify the house number of a residence, and this problem is even more difficult at night when the house numbers are hidden or obscured by darkness. This problem can make locating a specific address very difficult for guests, package delivery, and especially emergency services. Examples of emergency services that need to find a specific house number quickly would be medical, police or fire services. Minor delays in responding to an emergency situation can have severe negative consequences for the structure of the house, surrounding property, or occupants of the house. It is also important that arriving guests, delivery personnel and emergency personnel be able to locate a specific residence quickly and accurately.

Location of a specific address at night is sometimes accomplished by pointing a spotlight at a house in search of the house numbers. This method is time consuming, delaying the arrival of emergency services to the correct address, and also intrusive to the occupants of any nearby residence that does not require identification. Homes in rural or remote locations set back from the road or hidden by trees, vegetation or fences, for example, may not have numbers in a location visible from the street, making searching for a specific residence very difficult.

Additionally, house numbers are typically preset in only one location, facing only one direction, such that a viewer must be in only a certain location to read the house numbers.

### SUMMARY OF THE INVENTION

The present invention provides an efficient and effective solution to the problems of locating the house numbers of a residence by providing a structure having long metal posts that can be driven into the ground to secure the signaling light and house numbers in a location remote from and unattached to the structure of the house. This location would preferably be one to make the sign structure more easily visible from the street when someone in search of the house number drives by the residence. The sign include larges numbers in any of several arrangements, either horizontal, diagonal or vertical, such numbers being of a size such they be easily seen from the street. The numbers on the sign may be replicated on more than one surface, pointing in more than one direction to provide identification opportunities from several locations. The numbers further could be coated with a reflective material, or the surface of the numbers could be prepared to provide improved reflective qualities to aid in identifying the numbers at night.

The structure would further contain at least one light beacon, of any chosen color including white, capable of being switched on or off, such light to aid in the identification of a specific residence. For example, if the police are told the residence requesting help has a blue light in the front yard, prompt identification of the correct residence location is enhanced. The light may either remain continuously illuminated, of flash on and off at a rate that draws attention to the light. Several lights of different colors may be provided for use in different situations, or to further provide unique identification. For example, a white light may be additionally provided to illuminate the area surrounding the light, as well as to aid identification of the location.

The lights of the sign may be powered by a primary or secondary (rechargeable) battery, or be connected to an exterior power source directly or indirectly provided by the electric utility providing electric power to the residence. The secondary batteries in this case may be recharged by solar cells or some other available recharging power source.

Additional illumination may be provided to aid in the reflective illumination and identification of the house numbers at night.

If the lights of the sign are battery powered, it is advantageous to control when the lights turn on and off to preserve battery power and extend the useful life of a battery in the sign before the battery needs replacing or recharging. To simplify installation, it is advantageous if there were no wires connected between the residence and the remotely located sign. In such case, a wireless remote control may be used to turn the lights on or off, while a photocell may indicate that sufficient light exists to see the numbers and the light output of a specific light may be reduced or eliminated. Additionally, clocks and timers may be provided to control the time of day or the duration of illumination of the lights to preserve battery or light bulb life.

The wireless remote control may utilize a light signal, radio signal or audio signal to communicate commands to control the operation of the light or lights of the sign. The sign contains an apparatus to receive the signal, decode the command and then control the light function as commanded. The method of use of the remote control and the method of automatically controlling the illumination of the lights of the sign are thus provided.

### BRIEF DESCRIPTION OF THE DRAWINGS

FIG. 1 is a perspective view of the sign in a preferred embodiment;

FIG. 2 is a perspective view of the sign in an alternate embodiment;

FIG. 3 is a block diagram of a control system in accordance with the present invention;

FIG. 4a-c are a perspective view and other views of an embodiment of the invention;

FIG. 5a-c are a perspective view and other views of an embodiment of the invention;

FIG. 6a-c are a perspective view and other views of an embodiment of the invention; and

FIG. 7a-c are a perspective view and other views of an embodiment of the invention;

### DETAILED DESCRIPTION OF THE INVENTION

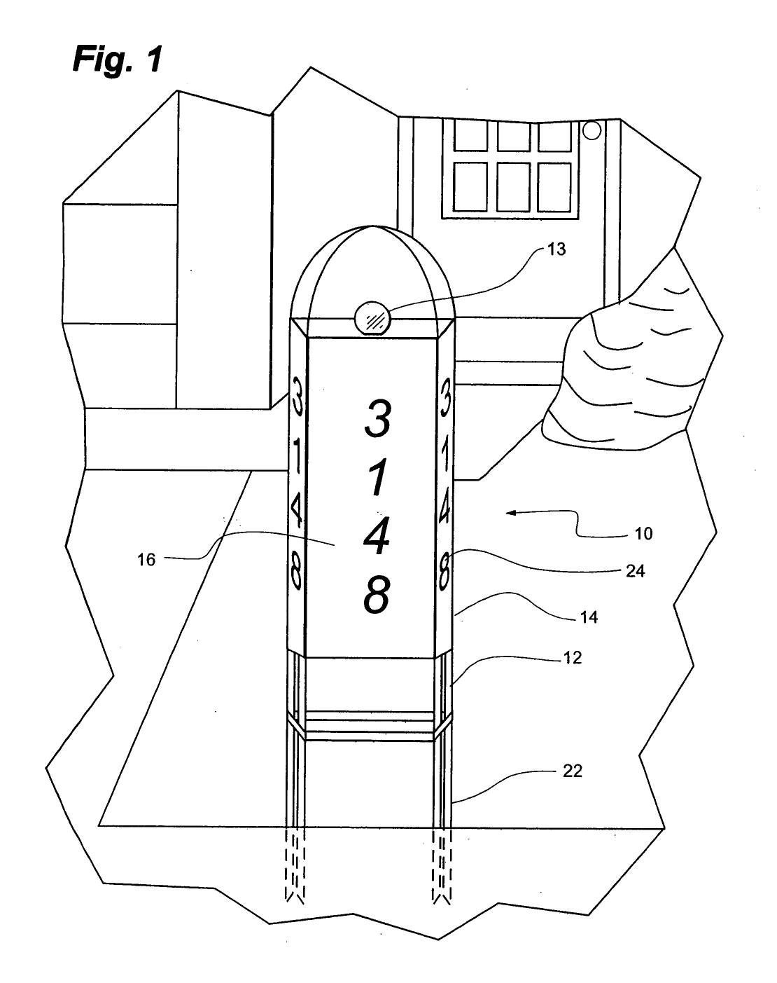

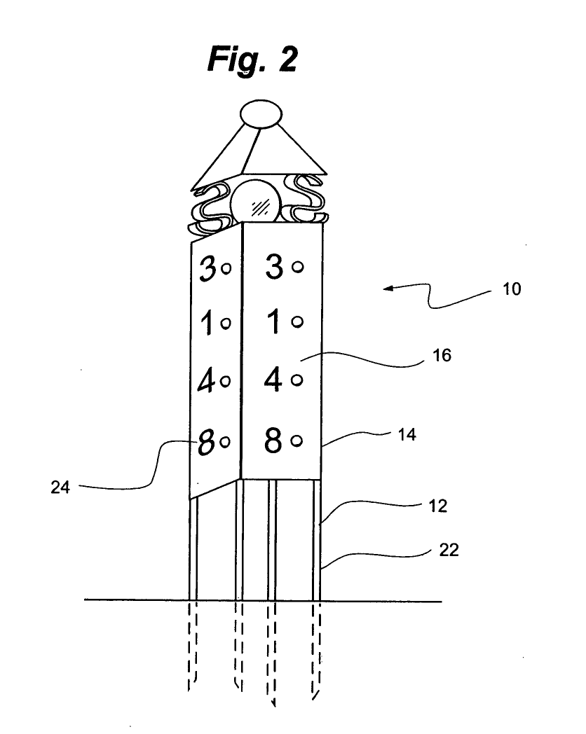

As illustrated in FIGS. 1 and 2, a structure is provided that has long poles to secure the sign into the ground in a manner that does not require digging because the sign is simply pushed or pounded into the ground at a convenient and visible location. Indicia displaying house numbers on the sign are arranged vertically on three sides, to aid identification of the numbers from the front or either side of the sign.

The top of the structure contains a battery-powered light or signal beacon under a clear dome. This light is controlled by a radio frequency or other remote control, and can be of any color, including white. The remote control is of a handheld size with a sufficient operating range to control the lights on the structure from inside a residence.

The signs in FIG. 1 and FIG. 2 have numbers greater than 3 inches in height, illuminated or coated with a reflective material. Additional small lights are placed next to the numbers to provide a reflected illumination of the numbers, which will aid in reading the numbers at night. The structure contains a radio receiver and electronic control mechanism to receive the commands given by the wireless remote control and then control the operation of the lights. The lights in FIG. 1 and FIG. 2 are powered by a replaceable primary cell battery of sufficient capacity to provide suitable operating life before battery replacement is required.

Signal beacon 10 of the present invention generally includes support 12, power supply 14, indicia display surface 16, controller transmitter 18 and receiver 20.

Support 12 may included stakes 22, or a weighted base (not shown). It is desirable that support 12 be easily placeable and removable so that signal beacon can be readily placed in a location visible to passers-by on a street or thoroughfare. Support 12 may also be placed permanently or semipermanently.

Indicia display surface 16 displays indicia such as a residential address 24. The indicia display surface 16 is multi-directionally visible and displays indicia prominently. Desirably, the indicia are illuminated or reflectorized to enhance visibility after dark.

Power supply 14 is preferably self-contained, such as a solar rechargeable battery. Power supply 14 may also be a conventional battery recharged by other means, or a power supply drawn from a local electric utility. Power supply 14 may also include solar cells for recharging batteries.

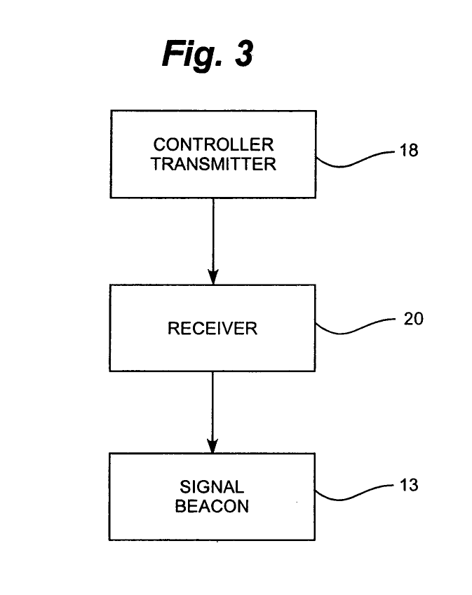

Referring to FIG. 3, controller transmitter 18 is desirably a wireless controller transmitter, although it may also be hardwired if desired. Receiver 20 is located at the signal beacon. Controller transmitter 18 is desirably hand-held and has a range sufficient to activate and deactivate signal beacon 10 from the location of the residence.

When activated, visible beacon 13 provides a prominent signal visible to passers-by or emergency crews or people trying to locate the residence. Visible beacon 13 may include a flashing light, strobe light, rotating beacon, or a pre-selected colored signal light.

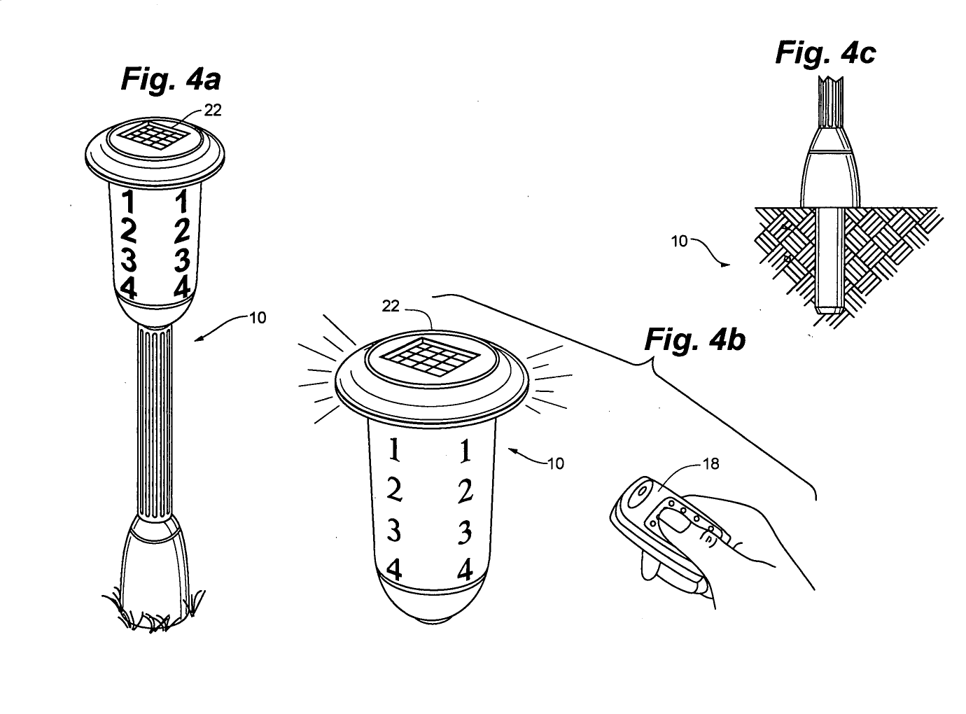

Referring to FIGS. 4a-c, controller transmitter 18 is hand-held and has a range sufficient to activate and deactivate signal beacon 10 from the location of the residence. Signal beacon 10 includes solar cell 22 to recharge batteries during daylight hours.

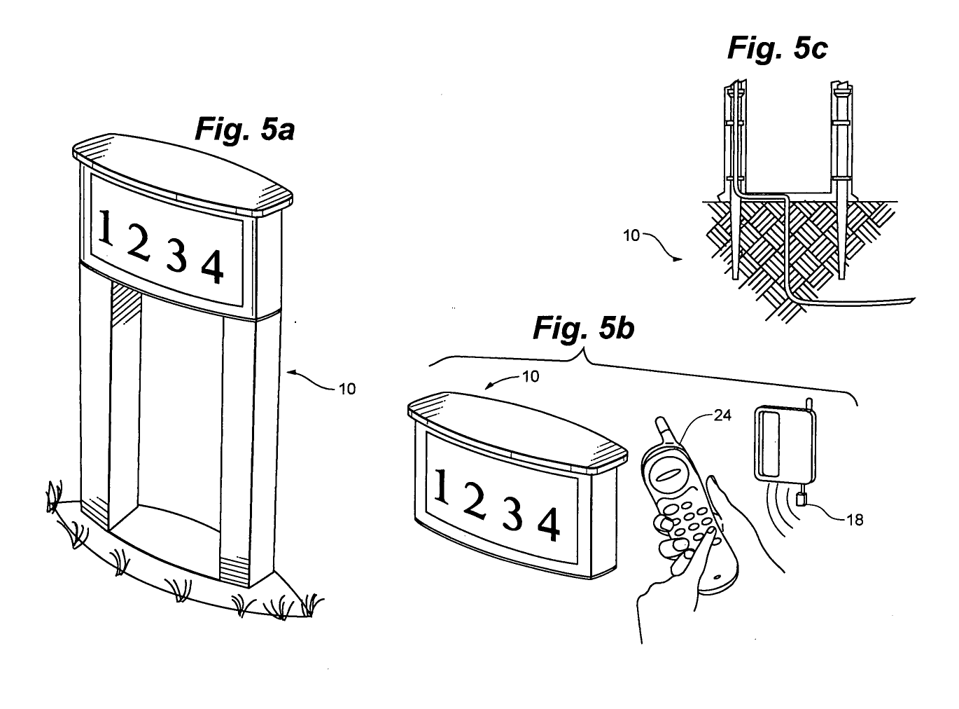

Referring to FIGS. 5a-c, controller transmitter 18 may be activated by telephone 24. Controller transmitter 18 may be automatically activated by a 911 call or when a call is dialed to a preselected phone number other than 911. In addition, controller transmitter 18 may also be activated by a call made from an outside location to the subject residence, for example, by dialing a preselected activation code after the call is made.

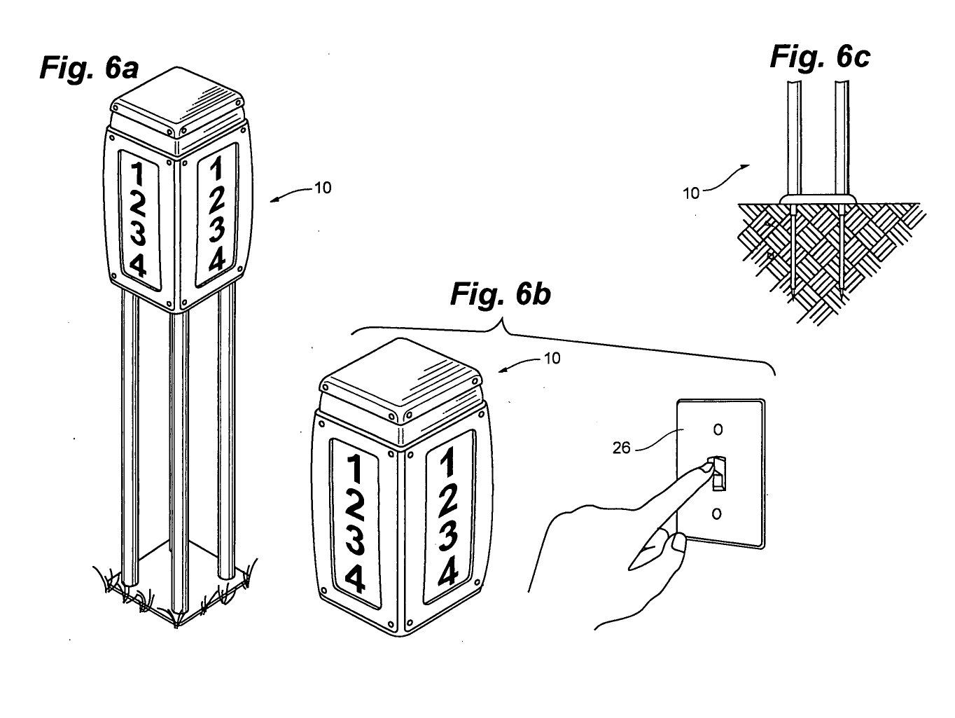

Referring to FIGS. 6a-c, controller transmitter 18 may be located in a switch 26 at a fixed location that transmits a wireless signal.

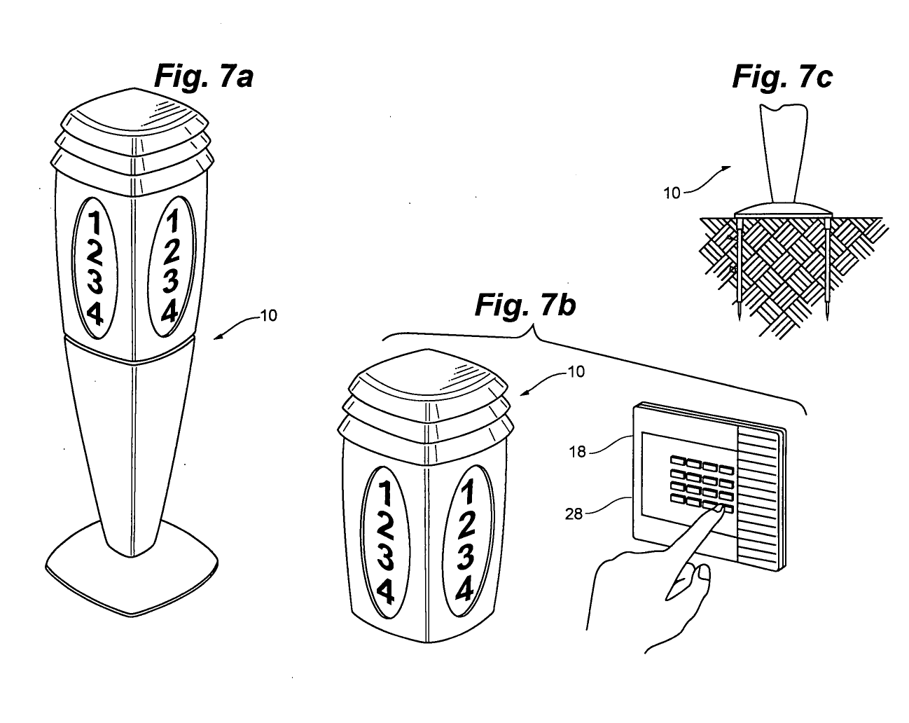

Referring to FIGS. 7a-c, controller transmitter 18 may be incorporated into or connected to a home security system 28 so that it can be activated by a, so called, panic button. In addition, controller transmitter 18 can be configured to activate beacon 10 in the event that an intrusion alarm is triggered or when a 911 signal is sent from the home security system 28. This aids police personnel or emergency crews in locating the residence as quickly as possible.

The present invention may be embodied in other specific form without departing from the spirit of the essential attributes thereof, therefore the illustrated embodiment should be considered in all respect as illustrative and not restrictive, reference being made to the appended claims rather than to the foregoing description to indicate the scope of the invention.

1. A system for visual signaling and address identification, comprising:
a power supply;
a visible signal beacon operably connected to said power supply, the visible signal beacon being capable of emitting a visible signal highly
visible to passersby;
a prominently visible multidirectional surface displaying indicia, the indicia being visible from at least two directions;
a controller/transmitter operably connected to a telephone, the controller/transmitter being activated by receiving a control signal from the telephone;
a receiver in operable communication with said controller/transmitter and operably connected to the visible signal beacon so as to allow selective
activation and deactivation of the visible signal beacon; and
a supporting structure supporting the visible signal beacon, the multidirectional visible surface displaying indicia and the wireless receiver.

2. The system as claimed in claim 1, in which the control signal from the telephone is generated when an outgoing call to a selected numerical sequence is dialed on the telephone.

3. The system as claimed in claim 1, in which the control signal from the telephone is generated when a preselected activation code is dialed by an incoming call made to the telephone.

4. The system as claimed in claim 1, in which the controller/transmitter is a wireless controller/transmitter.

5. The system as claimed in claim 1, further comprising a solar cell to charge a battery that comprises at least part of the power supply.

6. The system as claimed in claim 1, in which the signal beacon comprises a flashing light.

7. The system as claimed in claim 1, in which the signal beacon comprises a rotating light beacon.

8. The system as claimed in claim 1, in which the beacon is color coded in a predetermined color scheme to identify a residential location.

9. A system for visual signaling and address identification, comprising:
a power supply;
a visible signal beacon operably connected to said power supply, the visible signal beacon being capable of emitting a visible signal highly
visible to passersby;
a prominently visible multidirectional surface displaying indicia, the indicia being visible from at least two directions;
a controller/transmitter operably connected to and activated by a home security system;
a receiver in operable communication with said controller/transmitter and operably connected to the visible signal beacon; and
a supporting structure supporting the visible signal beacon, the multidirectional visible surface displaying indicia and the receiver.

10. The system as claimed in claim 9, in which the controller/transmitter is wireless.

11. The system as claimed in claim 9, in which the controller/transmitter is activated by a switch located at a fixed location.

12. The system as claimed in claim 9, in which the controller/transmitter is activated by a panic button.

13. The system as claimed in claim 9, in which the controller/transmitter is activated when an intrusion alarm is also activated.

14. The system as claimed in claim 9, in which the controller/transmitter is activated when the home security system dials a selected numerical sequence through a telephone system.

15. The system as claimed in claim 1, further comprising a solar cell to charge a battery that comprises at least part of the power supply.

16. The system as claimed in claim 1, in which the signal beacon comprises a flashing light.

17. The system as claimed in claim 1, in which the signal beacon comprises a rotating light beacon.

18. The system as claimed in claim 1, in which the beacon is color coded in a predetermined color scheme to identify a residential location.
